(19) United States
(12) Patent Application Publication
(10) Pub. No.: US 2010/0205420 A1
(43) Pub. Date: Aug. 12, 2010

(54) SYSTEM AND METHOD FOR REALIZING REMOTE TEST ON COMPUTER APPARATUS WITHOUT STORAGE DEVICE

(75) Inventors: Town Chen, Tianjin (CN); Qiu-Yue Duan, Tianjin (CN); Tom Chen, Taipei (TW)

Correspondence Address: STEVENS & SHOWALTER LLP, 7019 CORPORATE WAY, DAYTON, OH, 45459-4238, US

(73) Assignee: INVENTEC CORPORATION, Taipei (TW)

(21) Appl. No.: 12/367,631

(22) Filed: Feb. 9, 2009

(51) Int. Cl. G06F 15/177

(52) U.S. Cl. 713/2; 713/1

(57) ABSTRACT

A system and a method for realizing a remote test on a computer apparatus without a storage device are described, in which a client is enabled to select a desired operating system image file from a server and use the operating system image file to provide an initial processing on an operating system of the client. The testing method includes initializing a virtual disk in the client, registering the virtual disk to a basic input and output system (BIOS) of the client, connecting to a server over network according to connection information in the virtual disk, loading boot information into the client from the server, and performing a boot procedure on the client according to the boot information. Therefore, during a booting process of the client, a virtual disk is initialized in the server, so as to be used for booting the client.

### BACKGROUND OF THE INVENTION

1. Field of the Invention

The present invention relates to a power on self test (POST) system on a client and a testing method, and more particularly to a system for realizing a remote test on a computer apparatus without a storage device and a testing method thereof.

2. Related Art

As the transmission rate of the network has been continuously increased, the applications of the network are no longer limited to browsing web pages or transmitting data. Someone has proposed to utilize the existing network architecture to construct network computers. A network computer is configured in the client and does not have a storage device, but connects the client to the server over network, and then retrieves the data required for running the client from the server.

A disk that is usually connected to a remote terminal through the network often employs a preboot execution environment (briefly referred to PXE hereinafter). Besides retrieving data from a server to support the booting of the client, the PXE further uses the server to install an operating system or an application on a client. Generally, in order to obtain the remote operation functions described above, the PXE is burned in a flash memory on a network card. Once the client is booted, the PXE connects the client to the server base on an address of a network card of the server received by the client.

FIG. 1 is a flow chart of a PXE connecting operation in the prior art.

First, once the client is booted, a Boot ROM in the network card performs a self test before getting the control authority, and then sends out a request message by broadcasting (Step S110).

Once the server receives the request sent by the client, it returns an acknowledgement message to the client (Step S120). The acknowledgement message includes a default communication channel and a boot image file. The default communication channel is used to confirm the information related to the connection between the client and the server, such as a network protocol or a connection port. The boot image file is a boot system file that is required by the client.

Upon receiving the acknowledgement message sent by the server, the client sends back a response message to inform the server to start transferring the boot image file required by the client for booting (Step S130). The boot image file for supporting the booting of the client begins to be downloaded from the server (Step S140). Once the boot image file is completely received, the client boot-straps the booting of an operating system according to the boot image file (Step S150).

Although the installation or execution of the operating system on a client can be performed remotely through the PXE, the use of the PXE still causes a lot of inconveniences. The disadvantages of the PXE are listed as follows: 1. the network card must support the PXE, otherwise relevant functions cannot be enabled; 2. the PXE has a poor support to the TCP/IP layer, and does not support fiber communication protocols; 3. the PXE requires a user to define the network bootstrap program (NBP) to modify the interrupt vector table by themselves; and 4. the protocol of the PXE is based on network devices, such that it is difficult for the PXE to be used by other types of devices.

### SUMMARY OF THE INVENTION

In view of the above problems, the present invention is mainly directed to a testing system for an operating system of a virtual client, in which the client is enabled to select a desired operating system image file from a server and use the selected operating system image file to provide an initial processing on an operating system of the client.

In order to achieve the above objective, the present invention provides a system for realizing a remote test on a computer apparatus without a storage device, which includes a server and a client. The server is stored with a plurality of operating system image files. The client is connected to the server through Internet. The client further includes a virtual disk control module, a network storage device, and a network communication module. The virtual disk control module is disposed in an initial memory in the client. The virtual disk control module is used to provide a virtual disk, connect the virtual disk to a remote disk of the server, and order the server to load a selected operating system image file into the remote disk. The network storage device is used to receive a boot image file sent by the server. The network communication module is used to establish a relevant network communication with the server.

From another aspect, the present invention is directed to a method for realizing a remote test on a computer apparatus without a storage device, in which a client is enabled to select a desired operating system image file from a server and use the selected operating system image file to provide an initial processing on an operating system of the client.

In order to achieve the above objective, the present invention provides a testing method for an operating system of a virtual client, which includes initializing a virtual disk in a client, registering the virtual disk to a basic input and output system (BIOS) of the client, connecting to a server over network according to a connection information in the virtual disk, loading a boot information into the client from the server, and performing a boot procedure on the client according to the boot information.

According to an embodiment of the present invention, when the client is booted, the virtual disk is registered to the BIOS of the client, such that the client performs the booting motion from the virtual disk. During the booting process of the client, the client is connected to the remote disk in the server, and invokes a corresponding operating system image file, such that the client may run a corresponding operating system by using the virtual disk. Therefore, the client can perform the POST test without carrying any storage device.

### BRIEF DESCRIPTION OF THE DRAWINGS

The present invention will become more fully understood from the detailed description given herein below for illustration only, which thus is not limitative of the present invention, and wherein:

FIG. 1 is a flow chart of a PXE connecting operation in the prior art.

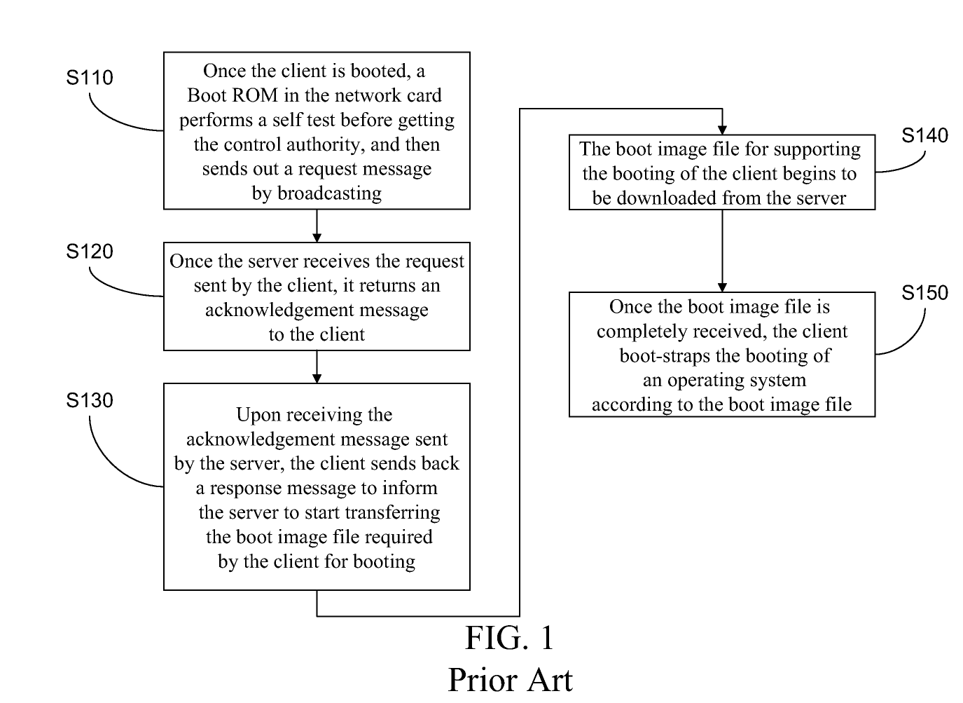

FIG. 2 is a schematic view of an architecture of a system according to the present invention.

FIG. 3 is a flow chart of operations according to the present invention.

FIG. 4 is a schematic flow chart of loading boot information.

FIG. 5 is a schematic view of a connection between a virtual disk and a remote disk according to the present invention.

### DETAILED DESCRIPTION OF THE INVENTION

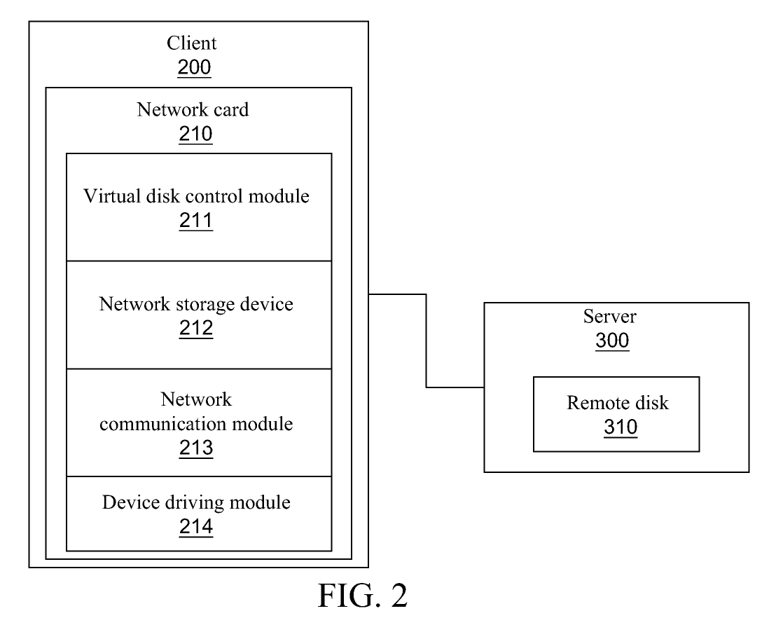

FIG. 2 is a schematic view of an architecture of a system according to the present invention. When a client 200 is booted, the client 200 initializes a virtual disk, and connects to a remote disk 310 in a server 300. The client 200 includes a virtual disk control module 211, a network storage device 212, a network communication module 213, and a device driving module 214.

The virtual disk control module 211 is configured in the client 200 and used to provide a virtual disk. The virtual disk control module 211 is connected to the remote disk 310 in the server 300 and copies a boot image file in the remote disk 310 into the virtual disk.

The network storage device 212 is used to receive the boot image file sent by the server 300. Once the network storage device 212 finishes the loading of the remote disk 310, the virtual disk registers to the BIOS of the client 200. The registration to the BIOS of the client is the same as that of other storage devices. By means of such a registration motion, the BIOS may determine that the virtual disk is located in the client 200. After the initialization of all of the storage devices has been finished, the BIOS performs the booting motion according to the set disk.

In the present invention, it is set to be booted from the virtual disk provided by the virtual disk control module 211. The network communication module 213 is used to provide a network communication protocol for making communications with the server 300. In this embodiment, the network communication protocol may be, but not limited to, a transmission control protocol (TCP), fibre channel over IP (FCIP), internet small computer system interface (iSCSI), or internet fibre channel protocol (iFCP). The device driving module 214 is used to control a plurality of storage devices of the client 200, in which the storage devices are registers or memories.

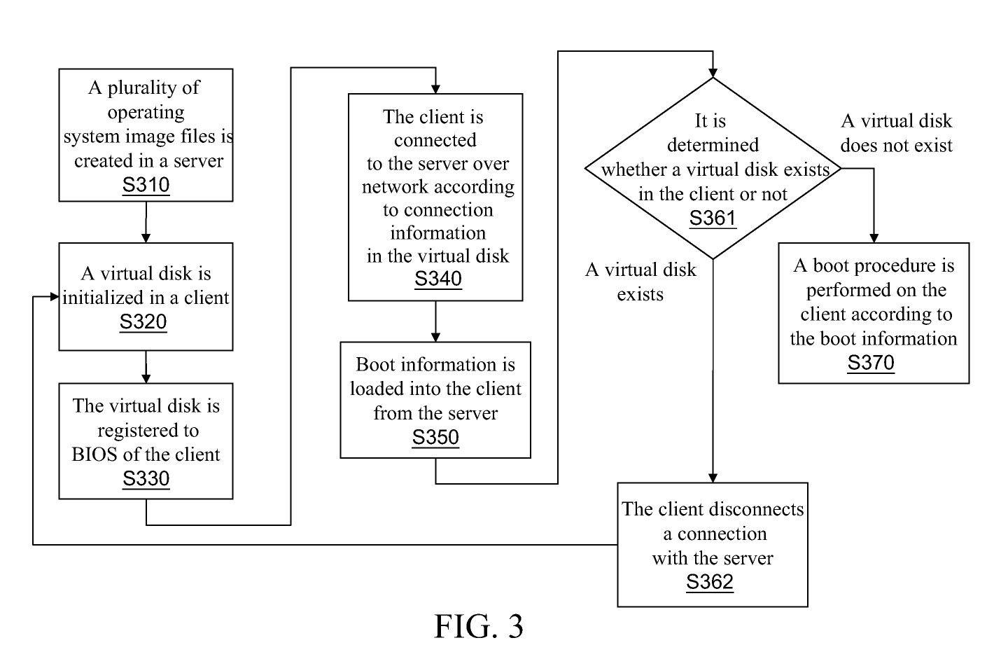

In order to clearly illustrate the operation flow among the components of the present invention, FIG. 3 is a flow chart of operations according to the present invention.

First, a plurality of operating system image files is created in a server (Step S310). The operating system image files may be, but not limited to, Microsoft windows operating system, DOS operating system, or Linux operating system.

A virtual disk is initialized in a client (Step S320). In the present invention, the virtual disk may be set as a virtual floppy drive, virtual optical disc drive, virtual flash memory, or virtual hard drive depending on the operating environment.

The virtual disk is registered to BIOS of the client (Step S330).

The client is connected to the server over network according to connection information in the virtual disk (Step S340). The connection information at least includes an operating system image file selected by the client, a serial number of the client, an IP address, and a network connection port.

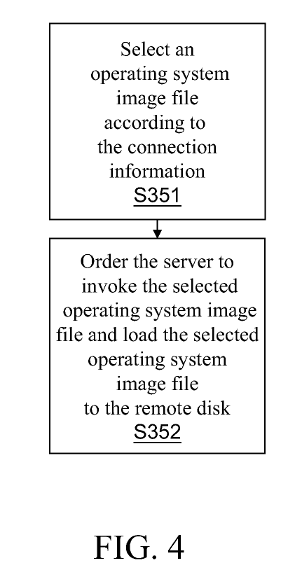

Boot information is loaded into the client from the server (Step S350). FIG. 4 is a schematic flow chart of loading boot information. Referring FIG. 4, Step S350 further includes the following steps: the server selects an operating system image file according to the connection information (Step S351); and ordering the server to invoke the selected operating system image file and load the selected operating system image file to the remote disk (Step S352).

Then, it is determined whether a virtual disk exists in the client or not (Step S361).

If a virtual disk exists in the client, the client disconnects a connection with the server (Step S362).

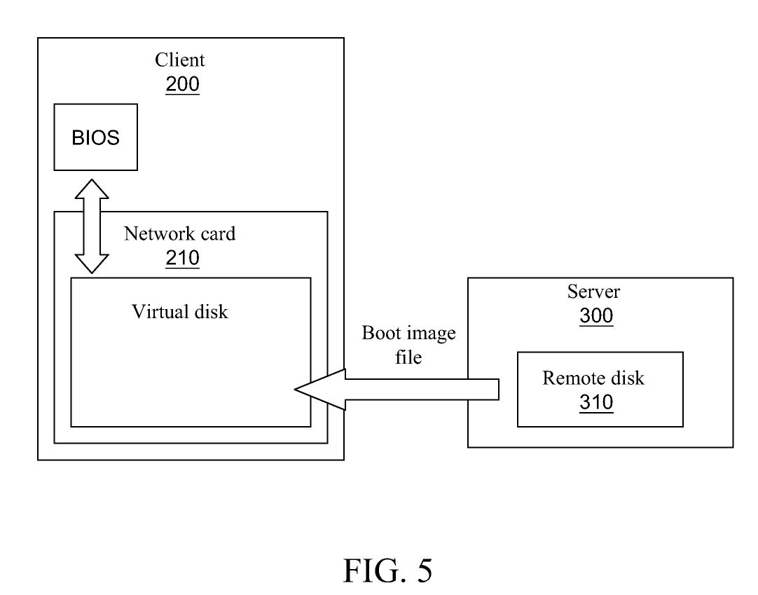

Finally, a boot procedure is performed on the client according to the boot information (Step S370). FIG. 5 is a schematic view of a connection between a virtual disk and a remote disk according to the present invention.

According to this embodiment of the present invention, once the client is booted, the virtual disk is registered to the BIOS of the client, such that the client is booted from the virtual disk. During the booting process of the client, the client is connected to the remote disk in the server, and invokes a corresponding operating system image file, such that the client may run a corresponding operating system by using the virtual disk. Therefore, the client can perform the POST test without carrying any storage device.

What is claimed is:

1. A system for realizing a remote test on a computer apparatus without a storage device, wherein a client is enabled to select a desired operating system image file from a server and use the operating system image file to provide an initial processing on an operating system of the client, the system comprising:
a server, stored with a plurality of operating system image files; and
a client, connected to the server through Internet, wherein the client further comprises:
a virtual disk control module, disposed in an initial memory in the client, for providing a virtual disk, connecting the virtual disk to a remote disk of the server, and ordering the server to invoke the selected operating system image file;
a network storage device, for receiving a boot image file sent by the server; and
a network communication module, for establishing relevant network communication with the server.

2. The system for realizing a remote test on a computer apparatus without a storage device according to claim 1, further comprising:
a device driving module, for controlling operations of a plurality of storage devices of the server.

3. The system for realizing a remote test on a computer apparatus without a storage device according to claim 1, wherein the storage devices are registers or memories.

4. The system for realizing a remote test on a computer apparatus without a storage device according to claim 1, wherein the network communication module adopts a transmission control protocol (TCP), fibre channel over IP (FCIP), internet small computer system interface (iSCSI), or internet fibre channel protocol (iFCP).

5. A method for realizing a remote test on a computer apparatus without a storage device, wherein a client is enabled to select a desired operating system image file from a server and use the operating system image file to provide an initial processing on an operating system of the client, the method comprising:
initializing a virtual disk in a client;
registering the virtual disk to a basic input and output system (BIOS) of the client;
connecting to a server over network according to a connection information in the virtual disk;
loading a boot information into the client from the server; and
performing a boot procedure on the client according to the boot information.

6. The method for realizing a remote test on a computer apparatus without a storage device according to claim 5, wherein before initializing the virtual disk, the method further comprises:
creating a plurality of operating system image files in the server.

7. The method for realizing a remote test on a computer apparatus without a storage device according to claim 6, wherein the step of loading the boot information further comprises:
selecting an operating system image file; and
ordering the server to invoke the selected operating system image file.

8. The method for realizing a remote test on a computer apparatus without a storage device according to claim 5, wherein the step of connecting to the server through Internet further comprises:
selecting a network protocol between the client and the server for making communications.

9. The method for realizing a remote test on a computer apparatus without a storage device according to claim 5, wherein before performing the boot procedure, the method further comprises:
determining whether the virtual disk exists in the client or not; and
if yes, disconnecting a connection between the client and the server.
